(19) United States
(12) Patent Application Publication
(10) Pub. No.: US 2011/0271220 A1
(43) Pub. Date: Nov. 3, 2011

(54) PROJECT PROGESS DISPLAY AND MONITORING

(75) Inventors: Charles Jay Remsberg, University Place, WA (US); Bruce Holt Taylor, Glacier, WA (US)

(73) Assignee: Steamboat Communications, Inc., University Place, WA (US)

(21) Appl. No.: 12/838,112

(22) Filed: Jul. 16, 2010

Related U.S. Application Data
(60) Provisional application No. 61/226,474, filed on Jul. 17, 2009.
(60) Provisional application No. 61/314,504, filed on Mar. 16, 2010.

(51) Int. Cl. G06F 3/048

(52) U.S. Cl. 715/772

(57) ABSTRACT

A project-schedule diagramming application enables generation of a diagram of a project schedule including a plurality of tasks. A data set defining each task is received from a user. The data set includes a start time and finish time for each task, an indication of at least one functional relationship between one or more tasks, and a type of each task. A user interface including an illustrated timeline is displayed, as well as a plurality of graphical elements respectively representing the plurality of tasks. Each graphical element illustrates the task start and finish times with reference to the timeline. The size of each graphical element is proportional to a duration of the represented task. Each graphical element is displayed in a format corresponding to the respective type of task represented by the graphical element. Connective elements between the graphical elements illustrating the functional relationships are displayed.

### CROSS REFERENCE TO RELATED APPLICATIONS

This application claims priority to U.S. Provisional Appl. No. 61/226,474 entitled “PROJECT VISUAL ANSWER” and filed Jul. 17, 2009, and U.S. Provisional Appl. No. 61/314,504 entitled “GENERATION OF NETWORK CHARTS USING PROJECT-SCHEDULING PARAMETERS” and filed Mar. 16, 2010, both of which are hereby incorporated by reference in their entireties.

### TECHNICAL FIELD

An embodiment of the invention relates to computational techniques for monitoring and analyzing a complex project including numerous tasks.

### SUMMARY OF THE INVENTION

According to an embodiment of the invention, a project-schedule diagramming application enables generation of a diagram of a project schedule including a plurality of tasks. A data set defining each task is received from a user. The data set includes a start time and finish time for each task, an indication of at least one functional relationship between one or more tasks, and a type of each task. A user interface including an illustrated timeline is displayed, as well as a plurality of graphical elements respectively representing the plurality of tasks. Each graphical element illustrates the task start and finish times with reference to the timeline. The size of each graphical element is proportional to a duration of the represented task. Each graphical element is displayed in a format corresponding to the respective type of task represented by the graphical element. Connective elements between the graphical elements illustrating the functional relationships are displayed.

### BRIEF DESCRIPTION OF THE DRAWING

The foregoing aspects and many of the attendant advantages of this invention will become more readily appreciated as the same become better understood by reference to the following detailed description, when taken in conjunction with the accompanying drawings, wherein:

FIG. 1 is a schematic view of an exemplary operating environment in which an embodiment of the invention can be implemented;

FIG. 2 is a block diagram of an exemplary operating environment in which an embodiment of the invention can be implemented; and

FIGS. 3-13 show screenshots of user interfaces in accordance with embodiments of the systems and methods described herein.

### DETAILED DESCRIPTION OF THE PREFERRED EMBODIMENT

Embodiments of the invention are operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

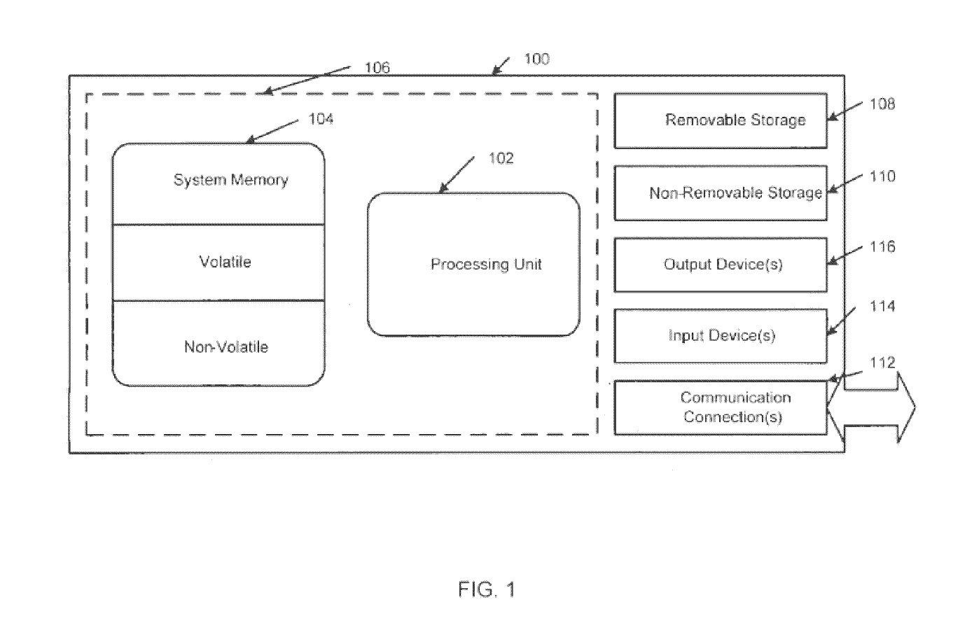

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of embodiments of the invention. Neither should the computing environment 100 be interpreted as having any dependency or requirement relating to any one or combination of components illustrated in the exemplary operating environment 100.

With reference to FIG. 1, an exemplary system for implementing an embodiment of the invention includes a computing device, such as computing device 100. In its most basic configuration, computing device 100 typically includes at least one processing unit 102 and memory 104.

Depending on the exact configuration and type of computing device, memory 104 may be volatile (such as random-access memory (RAM)), non-volatile (such as read-only memory (ROM), flash memory, etc.) or some combination of the two. This most basic configuration is illustrated in FIG. 1 by dashed line 106.

Additionally, device 100 may have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 100 may also have input device(s) 114 such as keyboard, mouse, pen, voice-input device, touch-input device, etc. Output device(s) 116 such as a display, speakers, printer, etc. may also be included.

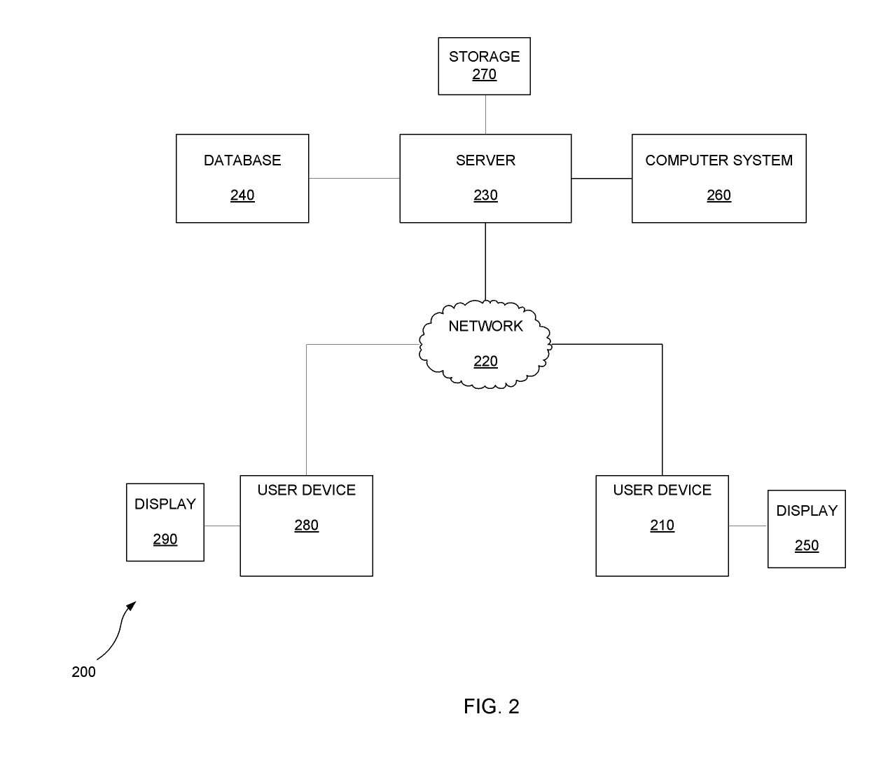

Referring now to FIG. 2, an embodiment of the present invention can be described in the context of an exemplary computer network system 200 as illustrated. System 200 includes electronic user devices 210, 280, such as personal computers or workstations, that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 2 includes one server 230 coupled to two user devices 210, 280 via the network 220, it should be recognized that embodiments of the invention may be implemented using two or more such user devices coupled to one or more such servers.

In an embodiment, each of the user devices 210, 280 and server 230 may include all or fewer than all of the features associated with the device 100 illustrated in and discussed with reference to FIG. 1. User devices 210, 280 include or are otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on the user devices 210, 280 can cooperate in two-way communication with server 230. As such, server 230 may be used to provide a computer-program product according to principles of inventive embodiments described herein to one or more of devices 210, 280. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

An embodiment sorts scheduling activities, and/or places them date scaled (to a calendar) on a network chart.

A network chart, as implemented in one or more user interfaces described herein, shows the logical relationships between tasks in a project. An embodiment uniquely sorts activities in relationship and date order, proportionally sizes a bar (to represent the activity) relative to a calendar, and/or otherwise places the bar on a chart.

The network chart turns discrete project data into visual information, used to plan, schedule, and/or manage projects. By graphically displaying data directly related to scheduled activities, an embodiment provides planning, scheduling, and/or management tools, to utilize the visual aspects of information gained from the network chart.

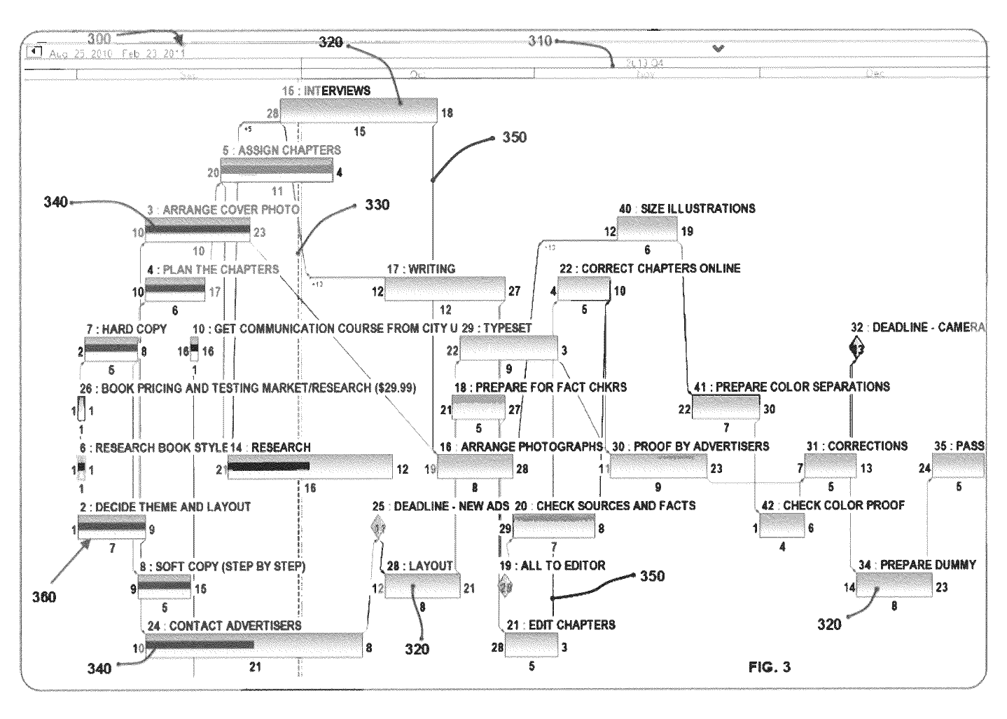

FIG. 3 illustrates a network-chart user interface 300 providing a sample network chart according to an embodiment. Such a user interface, as with all user interfaces discussed herein, may be generated by a user device 210, for example, to a display device 250. A timeline, such as a calendar 310, may be generated across the top, or other appropriate location, of the interface 300. Graphical elements, such as bars 320, represent scheduled tasks of a project. Each bar 320 has a length proportional to the duration of the represented task (i.e., the longer the task duration, the longer the bar). Relationship lines and/or arrows 350 define, or otherwise indicate, the functional and/or temporal relationships among the tasks and, consequently, the logic and flow of the project.

Elements, such as bars 320 and lines 350, of the interface 300 may be generated as a consequence of the user device 210 receiving from a user a data set defining each task of the project. Such data may be entered via conventional dialog boxes (not shown) generated by an embodiment to the display device 250. Alternatively or additionally, such data may be entered by the user employing a palette (not shown) of bars 320 and lines 350 that the user may place into the interface 300, using a conventional pointer device, by means of conventional cut-and-paste or click-and-capture techniques and select any desired color-coding or alternative shaping for bars/lines. Additionally, the user may, using the pointer device, stretch/contract bars 320, as well as move bars and lines 350 within the interface 300, to alter the temporal characteristics (i.e., duration, start/end time) of the associated tasks. The data set may include a start time for each task, a finish time for each task, an indication of at least one functional relationship between or among tasks, and a type of each task.

In an embodiment, once the device 210 receives the data set defining the project tasks, the device 210 may sort the tasks by date. After such sorting, the device 210 may place the earliest-occurring task bar 320 on a horizontal row 360 of the interface 300, and track the x-coordinates of the task information on the row on which the task bar is placed. The x coordinate “X max” describes the x coordinate (i.e., earliest date) on which a new task bar can be placed on that row. Any additional task bar 320 on the same row can be placed after X max. Subsequently, additional temporally successive task bars 320 may be placed on a chart row by device 210 by checking the row coordinates first above the previously placed task bar, then below the previously placed task bar (e.g., first iteration is n+/−1 for row n, second iteration is n+/−2 for row n, etc.). Task bars 320 may be placed in the interface 300 by earliest date to last date. Once all task bars 320 have been placed in the interface 300, lines 350 are then generated by device 210 to illustrate the logical relationships (finish-to-start, start-to-start, start-to-finish, finish-to-finish, with lag and leads) between the tasks.

The interface 300 may further provide an indication 330, such as a vertical dashed line, of a status date for which a user may wish to analyze the elements displayed within the interface. Progress meters 340, such as a filling element, may be included in one or more of the task bars 320 to indicate completion percentage of the task associated with such bar. Additionally, as illustrated in FIG. 3 and based on the entered data set, task-start date, task-end date, task duration, task ID number, and task description indices may be illustrated in the interface 300 proximal to each of bars 320.

Each task bar 320 may be displayed in a format of a plurality of formats (e.g., height, shape, color, etc.) to emphasize a distinguishing characteristic of its associated task. The format in which a task bar 320 is displayed corresponds to the respective type of task represented by the task bar 320. For example, if a task is on a “critical path” of the project, its associated task bar 320 may be colored red, while other non-critical-task bars may be colored blue, for example. In an embodiment, the critical path includes tasks that if delayed or changed will affect, as indicated by the user in the data set, the overall completion date of the project schedule.

An embodiment enables grouping of tasks and their associated bars 320 within the interface 300. Grouping allows sorting of tasks for persons who need specific task information, but may not remove how the task information is related to the entire project. For example, in the context of a construction project, tasks may be grouped by floor, (e.g., Basement, 1st Floor, 2nd Floor, etc.) then subgroup by trade (e.g., Electrician, Plumber, Carpenter, Painter, etc.). Each group can be separated in the interface 300 by, for example, a dashed line and/or heading between the groups. Grouping of tasks may chart the groups with a dashed line between the charted group sections. The relationship lines 350 between bars 320 continue to show relationships among tasks contained in different groups.

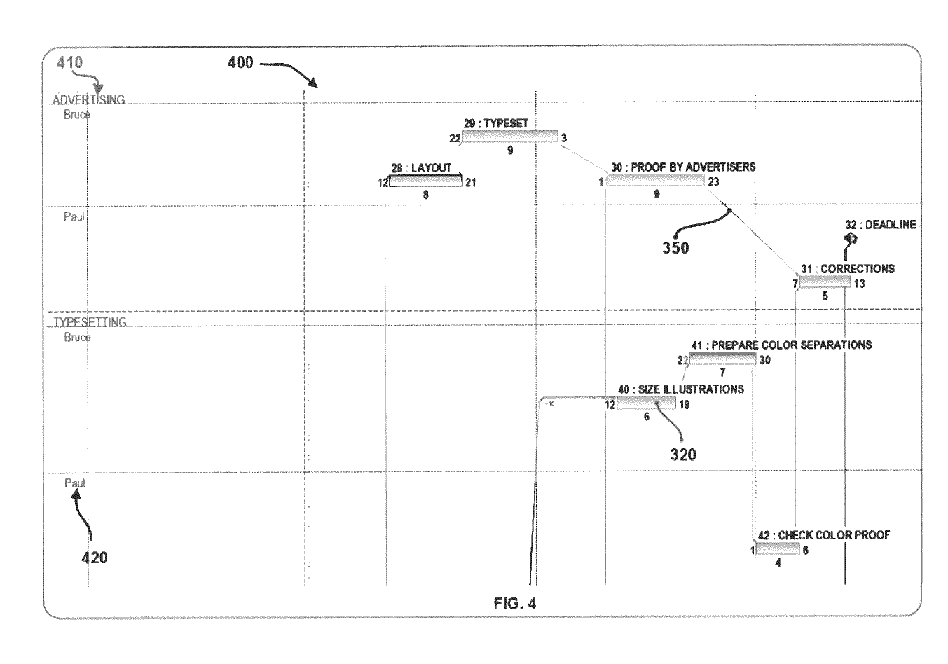

FIG. 4 illustrates an exemplary two-level grouping in a network-chart interface 400. The illustrated grouping 410 is by Task Summary (e.g., typesetting, write articles) and then sub-group 420 Resource (e.g., the party assigned to a particular task or tasks). An embodiment may enable expanding and contracting groupings by clicking on a “+/− button” (not shown) or other appropriate control. For example; two related activities could be separated by five groups with a relationship line 350 between them. An embodiment expands and contracts the groups, but maintains the relationship lines 350 between the visible related bars 320.

A stop light report is a common report in a spread sheet format indicating the status of project tasks. The stop light report may be a simple green, yellow, or red indicator that activities fall within a specific status. An embodiment may enable color-coding of the bars 320 to indicate the status of the associated task to illustrate possible impact on other tasks.

For example, bars 320 representing tasks varying from an ideal project schedule may be displayed in the color red, and bars representing tasks not varying from the ideal project schedule may be displayed in the color green. In such an embodiment, the entire project can be displayed ungrouped, and then grouped, filtered, grayed out and/or marked for specific tasks.

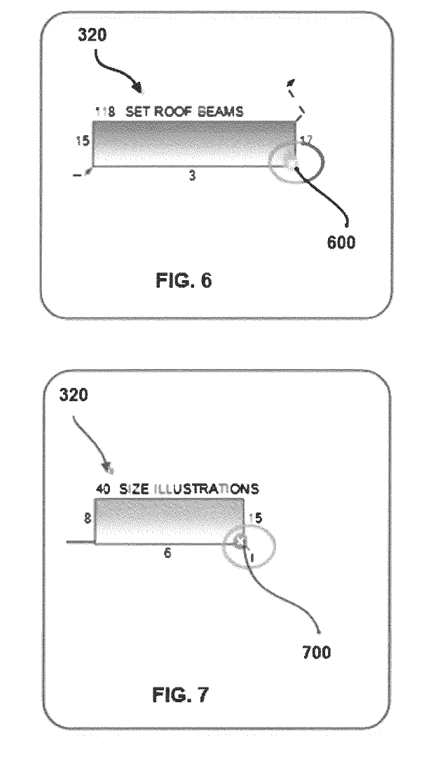

An embodiment may enable the use of path markers to enable better visualization of project logic paths. Specifically, the use of such path markers enhances the ability of a user to view tasks functionally related to a particular task of interest. For example, referring to FIG. 6, the user may select for marking a task bar 320 associated with a task of interest. By so doing, the interface 300 will graphically associate a marking element 600 with the selected bar 320. Additionally, the user may indicate that the user wishes to view the path of related tasks going back in time, such that task bars 320 having a preceding functional relationship to the selected task bar 320 are marked with a marking element 600, or forward in time, such that task bars 320 having a succeeding functional relationship to the selected task bar 320 are marked with a marking element 600.

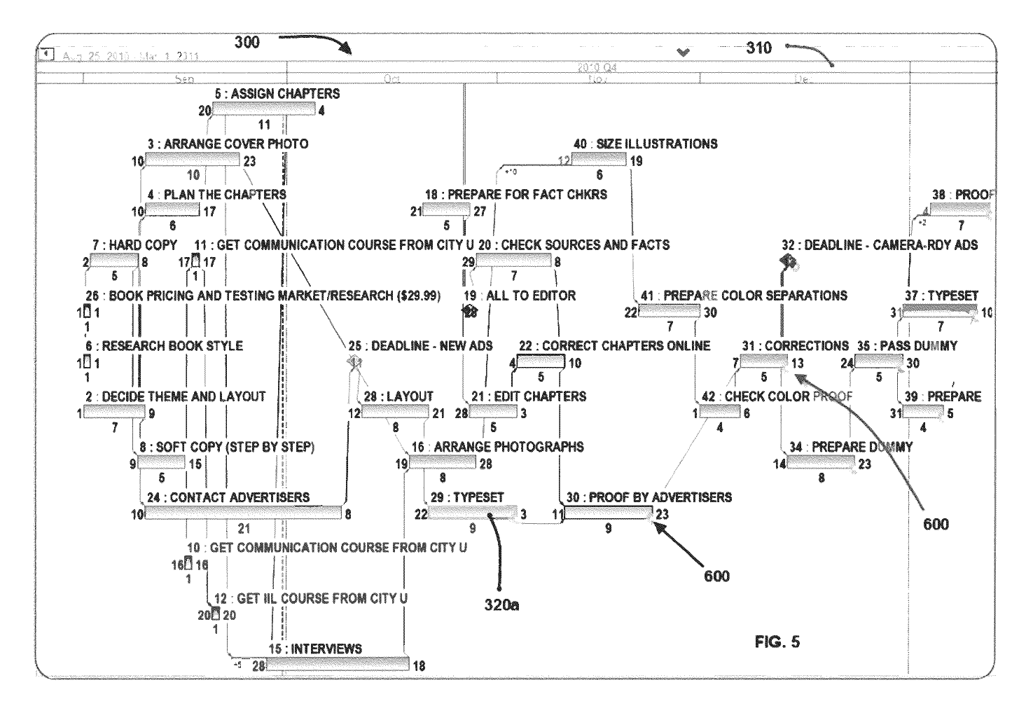

An exemplary interface 300 resulting from selections described above is illustrated in FIG. 5. In the example of FIG. 5, the bar 320a associated with task 29 “Typeset” has been selected by the user as the task of interest. Additionally, the user has selected to view the functional path forward in time. Consequently, all bars 320 associated with tasks functionally dependent on task 29, and scheduled to occur later in time, are marked with a marking element 600.

In an embodiment, the user may select for marking two different task bars 320 associated with two different tasks of interest, one later-in-time than the other. By so doing, the interface 300 may graphically associate a marking element 600 with each of the selected bars 320. In response, the device 210 may additionally mark with a marking element 600 only task bars 320 having both a preceding functional relationship to the selected later-in-time task bar 320 and a succeeding functional relationship to the other selected task bar 320.

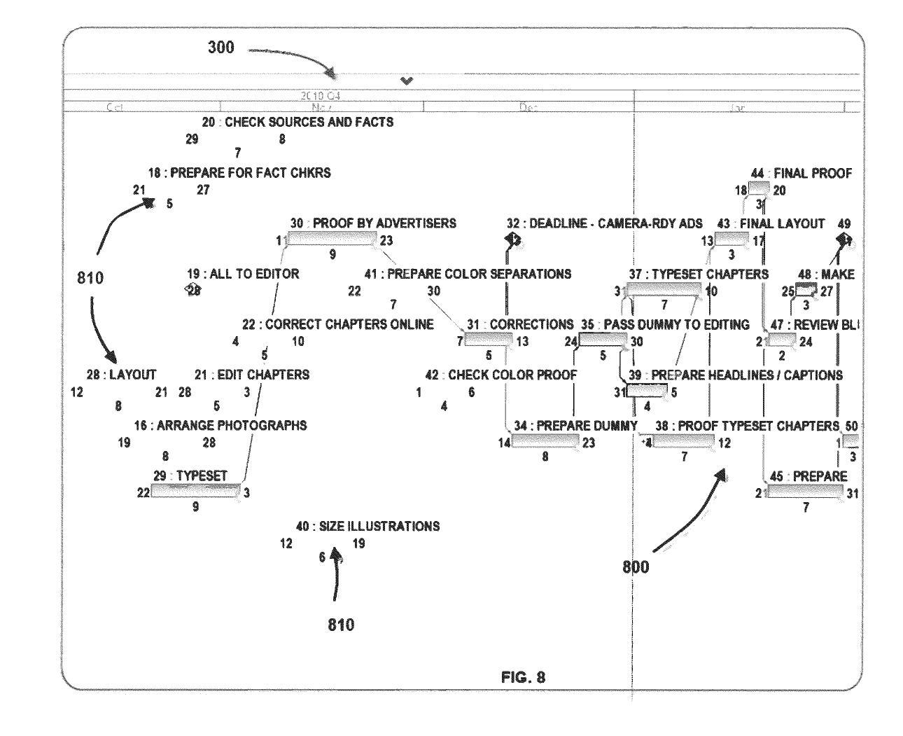

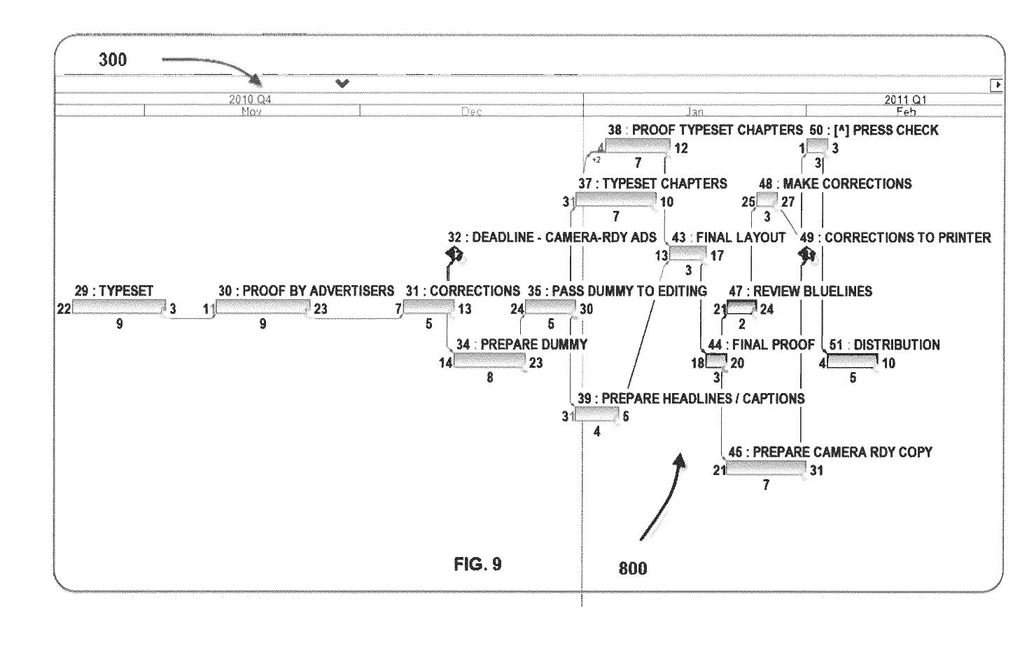

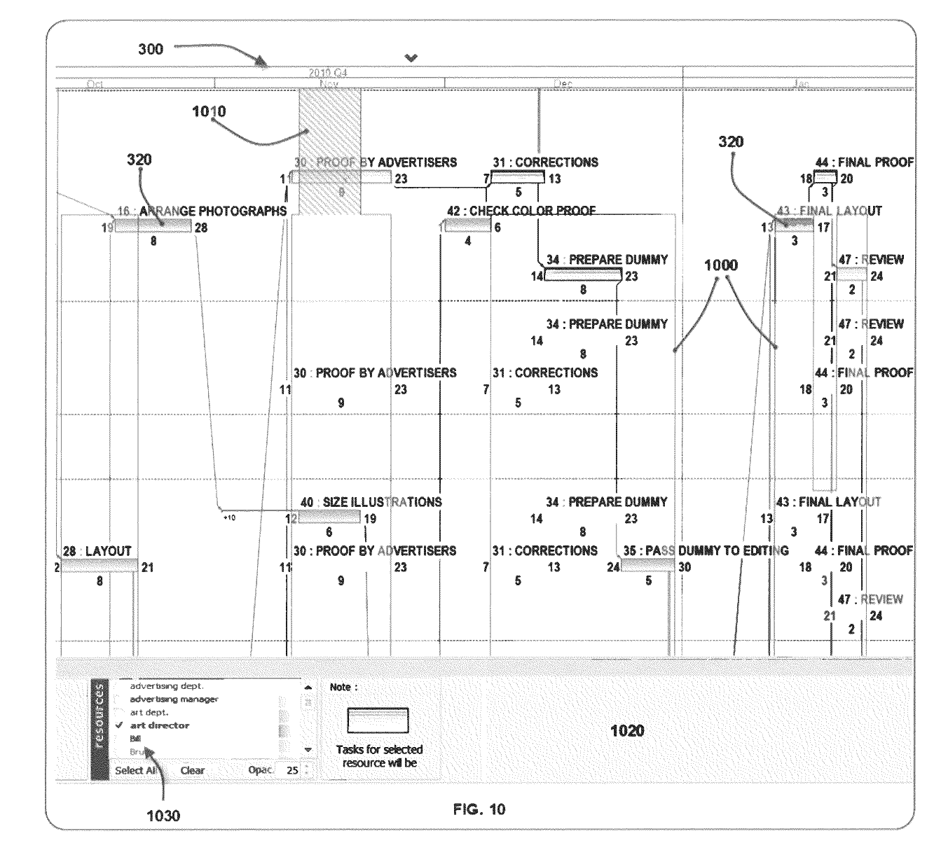

As illustrated in FIG. 8, once the desired path 800 has been delineated using marking elements 600, those task bars 810 not on the desired path may be distinguished from task bars on the desired path by, for example, graying out the task bars not on the desired path. Alternatively, and as illustrated in FIG. 9, those task bars 810 not on the desired path may be distinguished from task bars on the desired path by, for example, filtering out from display altogether within the interface 300 the task bars not on the desired path.

As illustrated in FIG. 7, if the later-in-time task is found to not be included in the path to the earlier-in-time task, then a missed path marker 700 is placed on the associated task bar 320 to indicate its absence from the path. Additionally, using a dialog box (not shown), a user may enter a range of tasks (e.g., task 20 to task 40) for which the user would like a path plotted. If the user expected a particular task (e.g., task 32) to be on the path in question, but such task is not on this path, an embodiment can similarly associate a missed path marker 700 with the missing task.

As illustrated in FIG. 10, an embodiment can enable visual resource leveling by providing a resource graph superimposed on the layout of task bars 320. Consequently, an embodiment can readily identify resource overloads. In such an embodiment, the above-discussed data set provided by the user may further include an identification of labor resources (e.g., number and type of laborers) assigned to complete each task. The resultant project diagram illustrated in interface 300 can be filtered to only show bars 320 associated with tasks that have specific resources assigned, can be filtered to only show tasks that cause a resource overload, or can show the entire project diagram as needed relevant to resource planning. As alluded to above, an embodiment can display resource graphs superimposed on the bars 320 to directly correlate resources to tasks.

For example, and as illustrated in FIG. 10, a resource graph 1000 may be displayed in the user interface 300 showing the number of assigned resources (e.g., art directors) as a function of a time period associated with the timeline and/or tasks to be performed within a discrete period of time, and superimposed on the displayed task bars 320. A numeric scale (not shown) to indicate resource levels indicated by the graph 1000 may be displayed either to the left or right side (i.e., y-axis) of the interface 300. The numeric scale may be similar to the calendar 310 across the top of the interface 300.

As a consequence of the coincidence of one or more specific labor-intensive tasks associated with bars 320, a resource spike 1010 resulting from an abnormally high involvement of particular resources in the associated time frame may occur and be indicated by graph 1000. Moreover, such a spike 1010 may be color-coded, for example, to distinguish it from the remainder of the graph 1000. Such a spike 1010 may be undesirable for any number of reasons. However, the graph 1000 and, consequently, project-resource parameters can be modified by the user moving one or more of the task bars 320 contributing to the spike 1010 forward or ahead in time (i.e., from a first portion of the user interface 300 to a second portion of the user interface), effectively rescheduling the performance of an associated task. Alternatively, the user may effect such a modification by modifying the functional relationship between two or more of the task bars 320 with at least one line 350.

Single or multiple resource types can be included in the resource graph, as selected using control panel 1020, which may be positioned below interface 300 as illustrated in FIG. 10. For example, the graph 1000 shown in FIG. 10 only illustrates resource allocation associated with art directors, as a consequence of the selection only of a check box 1030 associated with art directors. If the user selects additional check boxes 1030 associated with other types of resources, additional graphs (not shown) indicating the allocation of such other resources would be displayed in interface 300 in a manner similar to that of graph 1000.

Individual activities can be examined to measure performance by charting percent complete of task, compared to the baseline plan. Cost and/or work variations can be compared to the baseline plan. Individual activities can be quickly located that are in trouble when either cost or work is leading the percent of the plan. A bar that is leading the baseline means that an associated activity is costing more than planned in the budget. When an activity is over budget, the earned value is less than the amount spent on the task.

When activities are over budget, and the project is being progressed on a regular basis, project managers can focus on them as “exceptions,” to “manage by exception.”

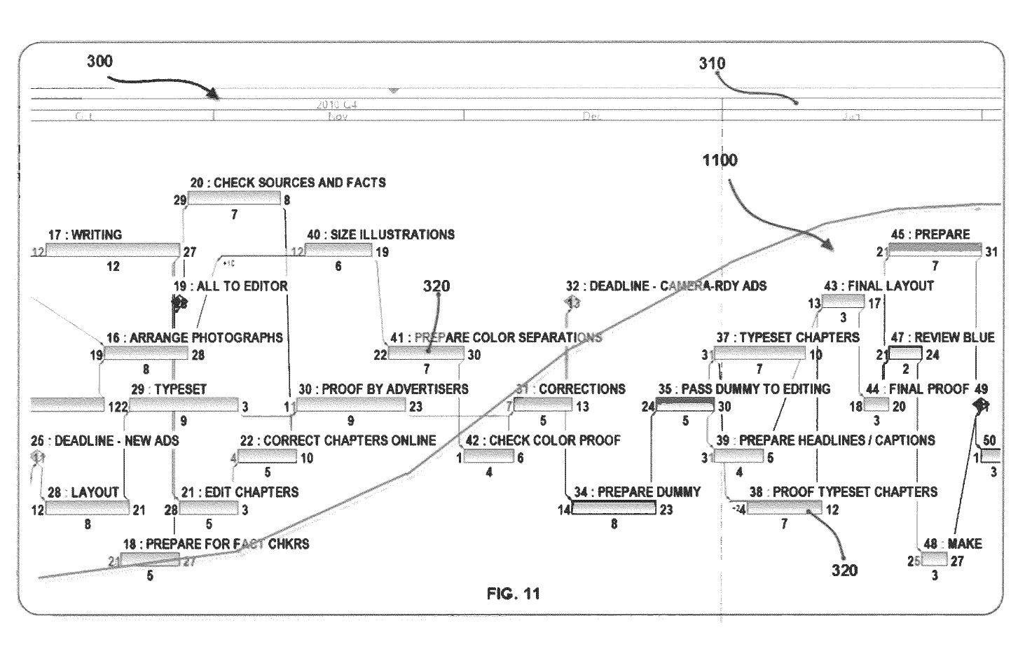

Project stakeholders want to know overall trends associated with a project and may not want to examine individual activities. They want to visually see trend information that identifies the project status: where it is relative to the schedule, and where it is relative to cost. Earned value “S” curves represent the cumulative cost of a project, and can predict how the project will perform relative to past performance. In an embodiment, and as illustrated in FIG. 11, an S-curve graph 1100 can represent the cumulative costs and, when superimposed on task bars 320 in interface 300, show the cost information as it directly relates to the corresponding tasks. In such an embodiment, the above-discussed data set provided by the user may further include an indication of a budgetary value to complete each task.

An embodiment may include a spreadsheet tabular-information interface (not shown) displayed proximal to interface 300 and that displays costs that are used to generate the graph 1100. A numeric scale (not shown) to indicate cost levels indicated by the graph 1100 may be displayed either to the left or right side (i.e., y-axis) of the interface 300. The numeric scale may be similar to the calendar 310 across the top of the interface 300. As illustrated in FIG. 11, at the start of the project (i.e., on the far left side of the calendar 310), the S-curve graph 1100 starts at the bottom and represents no or little value. As the S-curve graph 1100 progresses in time, it finally intersects near the top of interface 300 with the dollar scale at the total project earned value.

In an embodiment, multiple S curves can be graphed in interface 300 to easily compare planned project budget to current project expenditures. Each such S curve may be generated as a consequence of data entry by the user into the tabular-information interface, for example. If the current project S curve is above the planned project S curve, then the project may be over budget. If the current project S curve is below the planned project S curve, then the project may be under budget.

In an embodiment, “snapshots” of the interface 300 at various points in time may be saved to device 210, for example. Saved snapshots of the interface 300 can be used for historical reference to record the impact of change orders, for example, to the project. Claims in litigation can be based on the facts recorded in the snapshots.

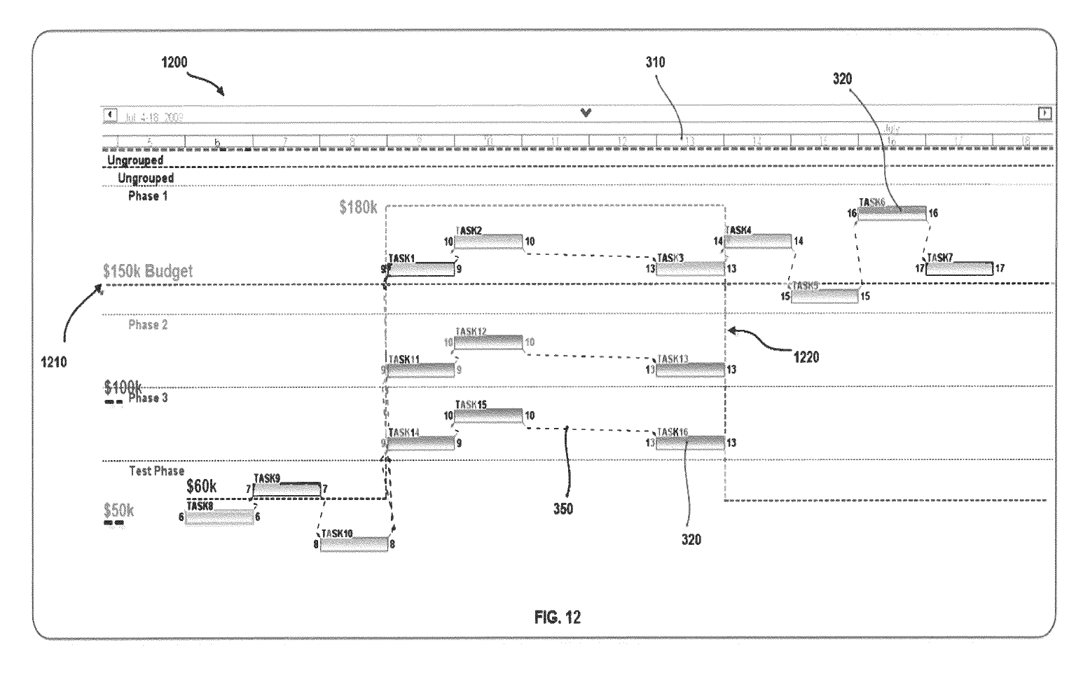

As illustrated in FIG. 12, an embodiment enables budgeting to be depicted as directly related to tasks represented by task bars 320 in an interface 1200. That is, instead of displaying columns of numbers in a spreadsheet in the conventional manner, cost information is associated and displayed in conjunction with task bars 320 in the interface 1200. The budget information can be graphed in a superimposed manner with respect to the task bars 320 to illustrate a direct correlation between the task scheduling and budget/cost information.

For example, and as illustrated in FIG. 12, a budget could be set at $150,000 and a graphed line 1210 generated across the interface 1200 relative to a money-value scale (not shown) on the left or right side of the interface to represent this budgetary setting. The illustrated example shows an average cost of $60,000 per task, with a graph 1220 illustrating the cumulative cost of all ongoing tasks in a given predetermined time period as indicated by calendar 310. As such, the cost of the tasks represented by bars 320 can be graphed relative to the money-value scale to yield a direct graphical relationship between cash flow/budget and associated tasks. The budget line 1210 can represent the cash flow available. In an embodiment, the budget line 1210 could be segmented to represent different amounts of dollars available during different time periods.

Although the exemplary calendar 310 illustrated in FIG. 12 is shown as divided into daily time periods, it should be recognized that the calendar of FIG. 12 (as well as any calendar illustrated and discussed herein) may be divided into any time period (e.g., days, weeks, months, quarters, etc.), as appropriate.

In the example illustrated in FIG. 12, where the graph 1220 illustrates that extant tasks are projected to be above the $150,000 budget line 1210 during one or more time periods, a user may act to rearrange bars 320 and/or connectors 350, in a manner discussed elsewhere herein, to reduce the costs of the project during such time periods.

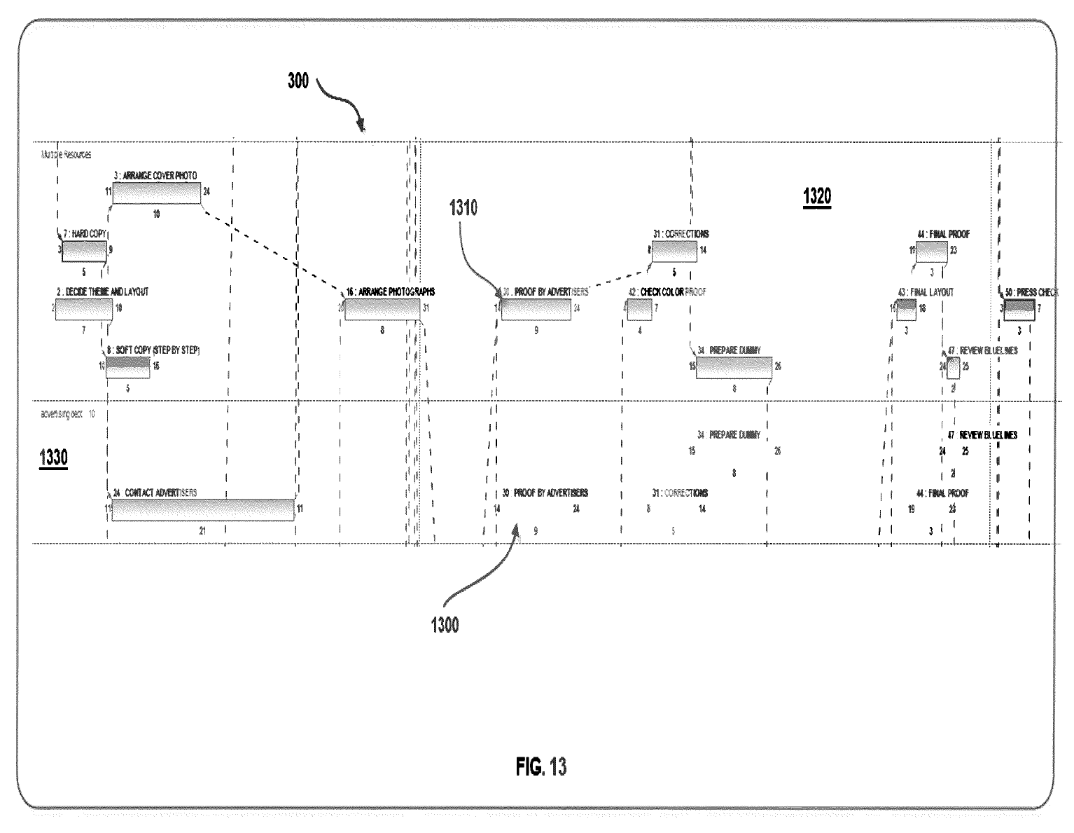

An embodiment, as illustrated in FIG. 13, includes the implementation of what may be termed “shadow task bars.” A shadow task bar 1300 may act as a visual placeholder that may communicate more information than an “original” task bar 1310 can on its own. Original task bars 1310 may appear in a first format, such as color-filled, while shadow task bars 1300 may appear in a different format, such as in gray, unfilled or other contrasting format.

For example, when, as illustrated in FIG. 13, an embodiment groups tasks by resources, tasks, such as “Proof By Advertisers” task 30, with multiple resources may belong to several groups: the Multiple Resources group 1320 at the top of the interface 300, as well as other groups (e.g., advertising dept. 1330) to which a task resource has been assigned. Below the Multiple Resources group 1320, individual resource groups appear in ascending alphabetical order.

The same task 30 displayed in the same way in several locations could cause confusion. Shadow task bars 1300 offer a solution to this problem by visually differentiating the original task bar 1310 from its copies. Shadow task bars 1300 visually communicate that a resource (or any other aspect being communicated) is assigned to a specific task along with other resources.

While a preferred embodiment of the invention has been illustrated and described, as noted above, many changes can be made without departing from the spirit and scope of the invention. For example, an Outline level and/or Work Breakdown Structure (WBS) code system can be used in connection with any interface described herein to determine increasing data per user requirements. Instead, the invention should be determined entirely by reference to the claims that follow.

The embodiments of the invention in which an exclusive property or privilege is claimed are defined as follows:

1. A computer-readable medium having stored thereon computer-readable instructions that, when executed by a processing device, enable the processing device to perform a method of generating a diagram of a project schedule including a plurality of tasks, the method comprising:
receiving from a user a data set defining each task of the plurality, the data set including a start time for each task, a finish time for each task, an indication of at least one functional relationship between each task of the plurality and another task of the plurality, and a type, of a plurality of types, of each task;
displaying a user interface including an illustrated timeline;
displaying in the user interface a plurality of graphical elements respectively representing the plurality of tasks, each graphical element illustrating the task start time and the task finish time with reference to the timeline, each graphical element having a size, the size of each graphical element being proportional to a duration of the represented task, each graphical element being displayed in a format of a plurality of formats, the format in which a graphical element is displayed corresponding to the respective type of task represented by the graphical element; and
displaying in the user interface connective elements between each graphical element and at least one other graphical element illustrating the at least one functional relationship.

2. The medium of claim 1, wherein displaying the graphical elements in a plurality of formats comprises color coding the graphical elements.

3. The medium of claim 1, wherein:
a set of tasks of the plurality defines a critical path;
graphical elements representing tasks defining the critical path are displayed in a first format; and
graphical elements representing tasks not defining the critical path are displayed in a second format different from the first format.

4. The medium of claim 1, wherein:
graphical elements representing tasks varying from an ideal project schedule are displayed in a first format; and
graphical elements representing tasks not varying from the ideal project schedule are displayed in a second format different from the first format.

5. The medium of claim 1, wherein the method further comprises:
receiving from the user a selection of a first one of the graphical elements;
receiving from the user a selection of a later direction along the timeline or an earlier direction along the timeline;
if the later direction was selected, displaying marking elements associated with only each graphical element having a succeeding functional relationship to the selected graphical element; and
if the earlier direction was selected, displaying marking elements associated with only each graphical element having a preceding functional relationship to the selected graphical element.

6. The medium of claim 1, wherein the method further comprises:
receiving from the user a selection of first and second graphical elements; and
displaying marking elements associated with only each graphical element having both a succeeding functional relationship to the selected first graphical element and a preceding functional relationship to the selected second graphical element.

7. The medium of claim 5, wherein the method further comprises one of:
displaying graphical elements having an associated marking element in a first format, and displaying graphical elements not having an associated marking element in a second format different from the first format; and
excluding from display the graphical elements not having an associated marking element.

8. The medium of claim 6, wherein the method further comprises one of:
displaying graphical elements having an associated marking element in a first format, and displaying graphical elements not having an associated marking element in a second format different from the first format; and
excluding from display the graphical elements not having an associated marking element.

9. The medium of claim 1, wherein:
the data set further includes an identification of labor resources assigned to complete each task; and
the method further comprises displaying in the user interface a graphical illustration of the number of assigned resources as a function of times illustrated by the timeline and superimposed on the displayed graphical elements, wherein the graphical illustration can be modified by one of:
the user moving one or more of the graphical elements from a first portion of the user interface to a second portion of the user interface, and
the user connecting two or more of the graphical elements with at least one connective element.

10. The medium of claim 1, wherein:
the data set further includes an indication of a budgetary value to complete each task; and
the method further comprises displaying in the user interface a graphical illustration of the project budget as a function of the positioning within the user interface of the displayed graphical elements and superimposed on the displayed graphical elements.

11. A method of transferring a computer program product from at least one first computer to at least one second computer connected to the at least one first computer through a communication medium, the method comprising the steps of:
(a) accessing, on the at least one first computer, computer-executable instructions that, when executed by a processing device, enable the processing device to generate a diagram of a project schedule including a plurality of tasks by performing at least the step of:
(1) receiving from a user a data set defining each task of the plurality, the data set including a start time for each task, a finish time for each task, an indication of at least one functional relationship between each task of the plurality and another task of the plurality, and a type, of a plurality of types, of each task,
(2) displaying a user interface including an illustrated timeline,
(3) displaying in the user interface a plurality of graphical elements respectively representing the plurality of tasks, each graphical element illustrating the task start time and the task finish time with reference to the timeline, each graphical element having a size, the size of each graphical element being proportional to a duration of the represented task, each graphical element being displayed in a format of a plurality of formats, the format in which a graphical element is displayed corresponding to the respective type of task represented by the graphical element, and
(4) displaying in the user interface connective elements between each graphical element and at least one other graphical element illustrating the at least one functional relationship; and
(b) transferring the instructions from the at least one first computer to the at least one second computer through the communications medium.

12. The method of claim 11, wherein displaying the graphical elements in a plurality of formats comprises color coding the graphical elements.

13. The method of claim 11, wherein:
a set of tasks of the plurality defines a critical path;
graphical elements representing tasks defining the critical path are displayed in a first format; and
graphical elements representing tasks not defining the critical path are displayed in a second format different from the first format.

14. The method of claim 11, wherein:
graphical elements representing tasks varying from an ideal project schedule are displayed in a first format; and
graphical elements representing tasks not varying from the ideal project schedule are displayed in a second format different from the first format.

15. The method of claim 11, wherein the processing device further performs the steps of:
receiving from the user a selection of a first one of the graphical elements;
receiving from the user a selection of a later direction along the timeline or an earlier direction along the timeline;
if the later direction was selected, displaying marking elements associated with only each graphical element having a succeeding functional relationship to the selected graphical element; and
if the earlier direction was selected, displaying marking elements associated with only each graphical element having a preceding functional relationship to the selected graphical element.

16. The method of claim 11, wherein the processing device further performs the steps of:
receiving from the user a selection of first and second graphical elements; and
displaying marking elements associated with only each graphical element having both a succeeding functional relationship to the selected first graphical element and a preceding functional relationship to the selected second graphical element.

17. The method of claim 15, wherein the processing device further performs one of the steps of:
displaying graphical elements having an associated marking element in a first format, and displaying graphical elements not having an associated marking element in a second format different from the first format; and
excluding from display the graphical elements not having an associated marking element.

18. The method of claim 16, wherein the processing device further performs one of the steps of:
displaying graphical elements having an associated marking element in a first format, and displaying graphical elements not having an associated marking element in a second format different from the first format; and
excluding from display the graphical elements not having an associated marking element.

19. The method of claim 11, wherein:
the data set further includes an identification of labor resources assigned to complete each task; and
the processing device further performs the step of displaying in the user interface a graphical illustration of the number of assigned resources as a function of times illustrated by the timeline and superimposed on the displayed graphical elements, wherein the graphical illustration can be modified by one of:
the user moving one or more of the graphical elements from a first portion of the user interface to a second portion of the user interface, and
the user connecting two or more of the graphical elements with at least one connective element.

20. The method of claim 11, wherein:
the data set further includes an indication of a budgetary value to complete each task; and
the processing device further performs the step of displaying in the user interface a graphical illustration of the project budget as a function of the positioning within the user interface of the displayed graphical elements and superimposed on the displayed graphical elements.
